(19) United States
(12) Patent Application Publication
(10) Pub. No.: US 2026/0149107 A1
(43) Pub. Date: May 28, 2026

(54) CONTROL UNIT FOR HOME AUTOMATION INSTALLATION AND ASSOCIATED HOME AUTOMATION INSTALLATION

(71) Applicant: SOMFY ACTIVITES SA, CLUSES (FR)

(72) Inventor: Baptiste BAUDRY, CLUSES (FR)

(21) Appl. No.: 19/123,247

(22) PCT Filed: Oct. 23, 2023
(86) PCT No.: PCT/EP2023/079458

§ 371 Date: Apr. 22, 2025

(30) Foreign Application Priority Data
Oct. 24, 2022 (FR) FR2211003

(51) Int. Cl. H01M 50/271; H01M 50/216

(52) U.S. Cl. CPC H01M 50/271; H01M 50/216

(57) ABSTRACT

This control unit (16) for a home automation installation comprises a main body (20), which houses a compartment (V20) for receiving a battery, and a cover (32) for closing the compartment. The cover comprises a hinge portion (34), which is configured to engage with the main body (20) so that the cover (32) is rotatable relative to the main body, a sealing portion (36) and a locking clip (40). The clip (40) is U-shaped, resiliently deformable and comprises a free end which is referred to as the locking end and is configured to be received in a complementary recess (60) provided in the main body when the cover (32) is in the closed position, the clip (40) then being located on one side of the internal median plane (P30) of the main body, while the locking end (43B) is located set back from the outer face (28).

This invention relates to a control unit for a home automation installation, and to a home automation installation comprising such a control unit.

In the field of home automation, it is known to control various items of equipment in a home, for example a closure system with a motorised roller shutter, lighting, etc., by means of a control unit, also called a control point, communicating wirelessly with the equipment. Such a control point is generally powered by one or more electric batteries, in particular by so-called button batteries, for example lithium batteries. To make battery replacement easier, the battery or batteries are usually housed in a compartment with a cover.

To prevent these button batteries being swallowed by small children, it is vital that the compartment is properly sealed and cannot be opened accidentally, for example if the control unit is handled by small children, or if it is dropped or crushed. Some standards or draft standards, such as IEC 62368-1 3^{rd} edition, require that the cover of a battery compartment cannot be opened using fingers, but require the use of a tool.

It is known to secure the battery compartment cover of a control unit by means of a resilient release clip. The clip includes a support area, which can usually be manipulated by hand.

In particular, EP 3 651 230 describes an electronic device powered by a button cell, in which the button cell is held in place in a recess of the device by means of a cover. The cover is fitted with a resilient release clip. In the locked position, a free end of the resilient clip passes through an opening in a main cover of the device and thus extends partially above this main cover, so that the free end of the resilient clip can be manipulated directly with the fingers to unlock the cover.

US2021/344078 describes a medical device with a secure battery compartment. The battery compartment is closed by a cover that is locked by means of a resiliently deformable hook. The hook is fitted with barbs that cooperate in the locked position with projections on a deformable arm of the compartment. The cover is unlocked by deforming one free end of the hook with the fingers and simultaneously pressing a complementary unlocking button using a pointed or thin tool.

To comply with the standard, however, it is necessary to ensure that the clip cannot be unlocked by hand.

On the other hand, given the small thicknesses of a control point, it is necessary for this clip to be able to act resiliently at a height less than the thickness of the recess provided for the battery or batteries. Finally, this type of resilient clip locking device is subject to improvement to guarantee reliability over time in relation to careless handling, particularly when opening the battery compartment.

It is these problems that the invention aims to remedy, in particular, by proposing a control unit with improved safety.

To this end, the invention relates to a control unit for a home automation installation, the control unit comprising:
a main body (20), which provides a compartment (V20) for receiving one or more batteries, the compartment opening out in a depth direction (Z20) on an outer face (28) of the main body via an opening (30) which extends in a median plane (P30) orthogonal to the depth direction (Z20),
a cover (32) for closing the compartment, the cover:
   being rotatable relative to the main body (20) about an axis of rotation (A34) parallel to the median plane, the axis of rotation (A34) being located on a so-called proximal side of the compartment (V20), and
   being movable relative to the main body in an opening movement (F32) between a closed position, in which the cover prevents access to the compartment, and an open position, in which the cover does not prevent access to the compartment,
      in which:
the cover comprises:
   a hinge portion (34), configured to cooperate with the main body (20) so that the cover (32) is rotatable relative to the main body about the axis of rotation (A34),
   a sealing portion (36), which is configured to close the opening (30) when the cover is in its closed position, and
   a locking clip (40), which is located on one side of the cover (32), opposite the hinge portion (34) with respect to the sealing portion (36), the clip (40) having a U-shape with a captive wall (42A) and a free wall (42B) connected to each other by a rounded base (42C), the free wall comprising a free end referred to as the locking end (43B), which is configured to be received in a complementary recess (60) formed in the main body (20) when the cover (32) is in the closed position, preventing the opening movement (F32) of the cover, the cover then being in a locked configuration,
when the cover (32) is in the closed position, the clip (40) is located on one side of the median plane (P30) internal to the main body, with the locking end (43B) set back from the outer face (28), while an opening of the U is oriented in the same direction as the depth direction (Z20),
the clip (40) is resiliently deformable between a deployed configuration and a compressed configuration, the clip tending, by resilient return of the rounded base (42C), to return to its deployed configuration,
the cover (32) is in its locked configuration when the cover is in the closed position and the clip is in the deployed configuration, and
when the cover is in its closed position and the clip is in its compressed configuration, the clip does not prevent the opening movement (F32) of the cover and the cover is in an unlocked configuration.

Thanks to the invention, the rounded U shape of the clip distributes the deformation stresses of the main portion over the whole of the U, in particular over the two walls. In other words, when the cover is opened, the stress concentration is reduced, which reduces the risk of cracking and/or accidental breakage of the clip. This improves the safety of the control unit. In addition, the distribution of stresses on the walls and rounded base allows the locking clip to have a more limited height, enabling it to be housed within the limited thickness of the control unit. Furthermore, as the locking end is set back from the outer face, the risks of catching the locking end with a finger or fingernail, resulting in the compartment opening, are reduced. As such, a tool is required to open the battery compartment. This improves the safety of the control unit.

According to advantageous but not mandatory aspects of the invention, such a control unit may incorporate one or more of the following features, taken in isolation or in any combination that is technically feasible:
The sealing portion extends along a cover plane, which is parallel, in particular substantially coplanar, to the median plane when the cover is in the closed position.
The captive wall, the free wall and the rounded base of the clip are mechanically connected to the main body only via the locking end and via a captive end of the captive wall, opposite the base and connected to the sealing portion.
The mechanical connections of the locking end and the captive end of the captive wall lie substantially in a same plane perpendicular to the depth direction and set back from the median plane in the depth direction.
The complementary recess comprises at least one blocking wall, each blocking wall providing a blocking surface facing away from the depth direction, the locking end comprising at least two blocking faces, each blocking face bearing against a respective blocking surface when the cover is in the locked configuration, preventing opening movement of the cover, and the blocking faces being arranged set back, along the height direction when the cover is in the closed position, with respect to the sealing portion.
The main body comprises a clearance, which is recessed into the main body and is arranged between the complementary recess and the compartment, the complementary recess opening onto the clearance, which itself opens onto the outer face, the clearance being configured to receive part of the clip when the cover is in the closed position,
   and the main body further comprising a gap, which extends in the depth direction, which is formed in the main body and which connects the complementary recess to the outer face of the main body, the gap opening into the complementary recess in the vicinity of each blocking surface, so as to allow access from the outer face to a bearing face of the locking end when the cover is in the locked configuration, the bearing face being located in the vicinity of each blocking surface.
The gap has a passage dimension, measured between any two points on a contour of the gap parallel to the median plane, which is less than 5 mm, preferably less than 4 mm, even more preferably less than 3.5 mm.
The bearing surface is set back from each blocking face, while the bearing surface is inclined away from the captive wall with respect to the height axis, the height axis being colinear with the depth direction when the cover is in the closed position.
The gap has a chamfered opening and surfaces delimited by the blocking walls and the main body providing an area for inserting and supporting a tool in the gap.
The connecting lug comprises a centring reinforcement which projects from the inside of the cover and forms stop faces with the captive wall,
   while the reinforcement is configured to cooperate, in a form-fitting manner, with an indentation formed in the main body, the indentation forming stop surfaces, which are arranged opposite the stop faces of the reinforcement when the cover is in the closed position, so as to prevent translational movements of the clip perpendicular to the axis of rotation towards it or parallel to the axis of rotation.
The stop faces include:
   at least one transverse face, each transverse face being oriented towards the hinge axis when the cover is in the closed position, and
   two lateral faces, which face away from each other orthogonally to the hinge axis when the cover is in the closed position.
On the external side of the cover, the sealing portion and the clip are connected by a junction surface, while the junction surface has, in projection in a longitudinal plane of the cover, a convex profile with a radius of curvature.

The invention also relates to a home automation installation, in particular a closure or sun protection installation, which comprises a control unit as described above.

The invention will be better understood and other advantages thereof will become clearer in the light of the following description of two embodiment of a control method and a home automation installation in accordance with its principle, given by way of example only and made with reference to the appended drawings in which:

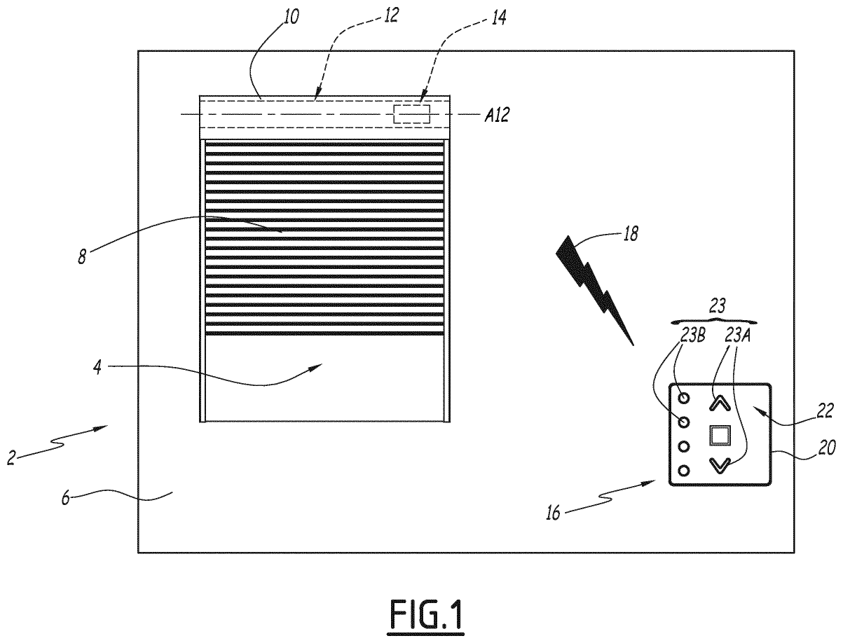

FIG. 1 shows a home automation installation in accordance with a first embodiment of the invention, with a control unit also in accordance with the invention, viewed from the front;

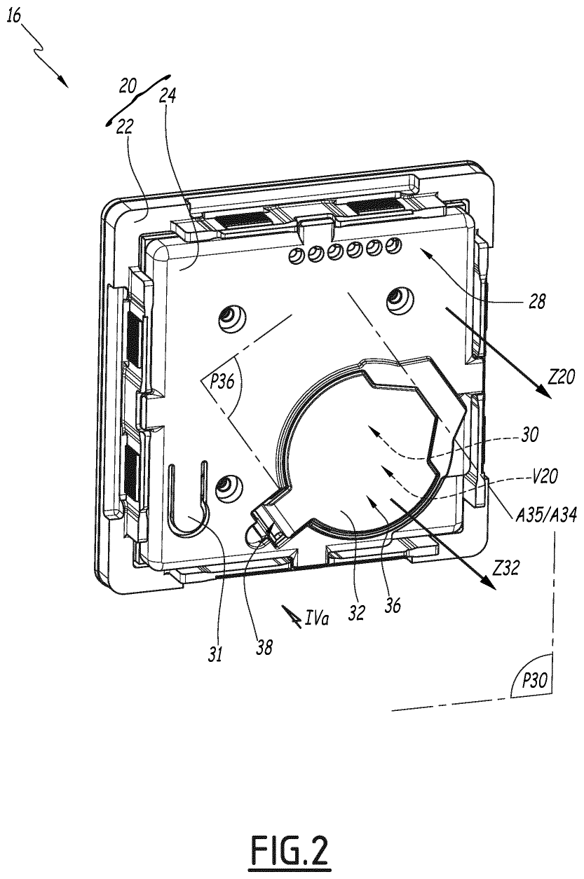

FIG. 2 is a rear perspective view of the control unit of FIG. 1, comprising a cover and shown in a closed configuration;

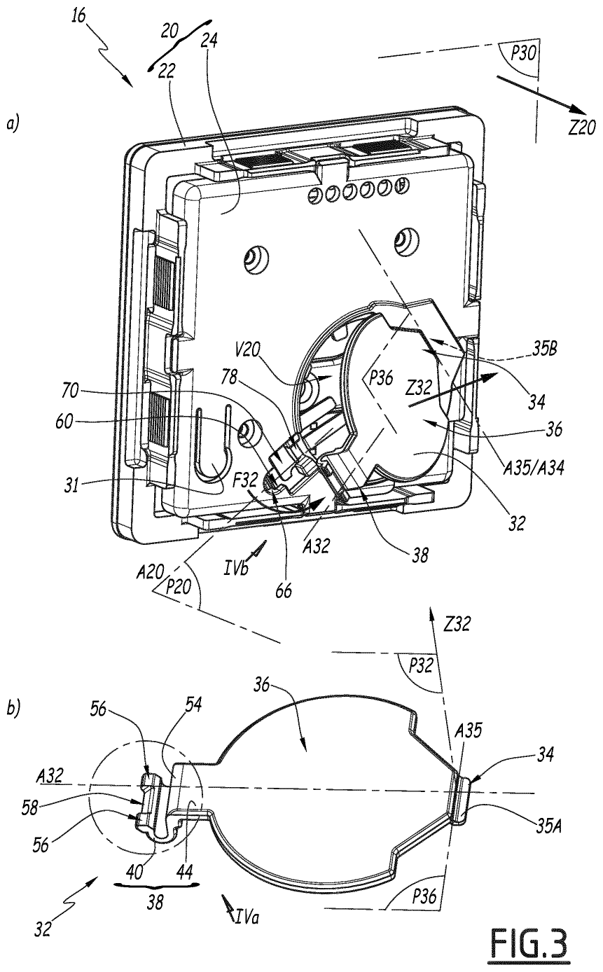

FIG. 3 shows, on two inserts a) and b) respectively, a rear perspective view of the control unit of FIG. 2, shown in an open configuration, and a perspective view of the cover of FIG. 2;

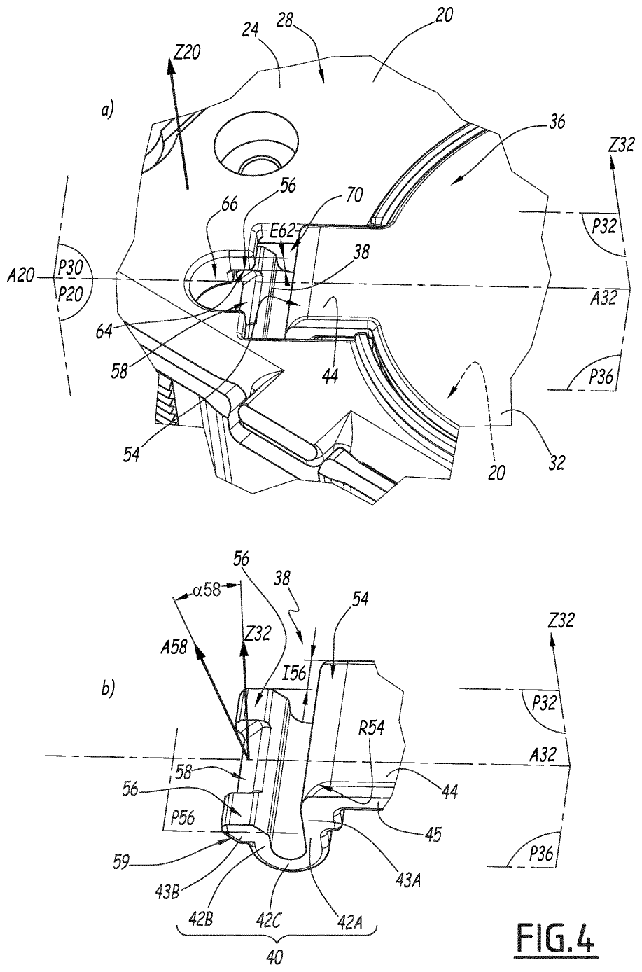

FIG. 4 shows, on two inserts a) and b) respectively, a detail of the control unit in FIG. 2, seen along an arrow IVa in FIG. 2, and a detail of the cover in FIG. 3b), seen on a larger scale;

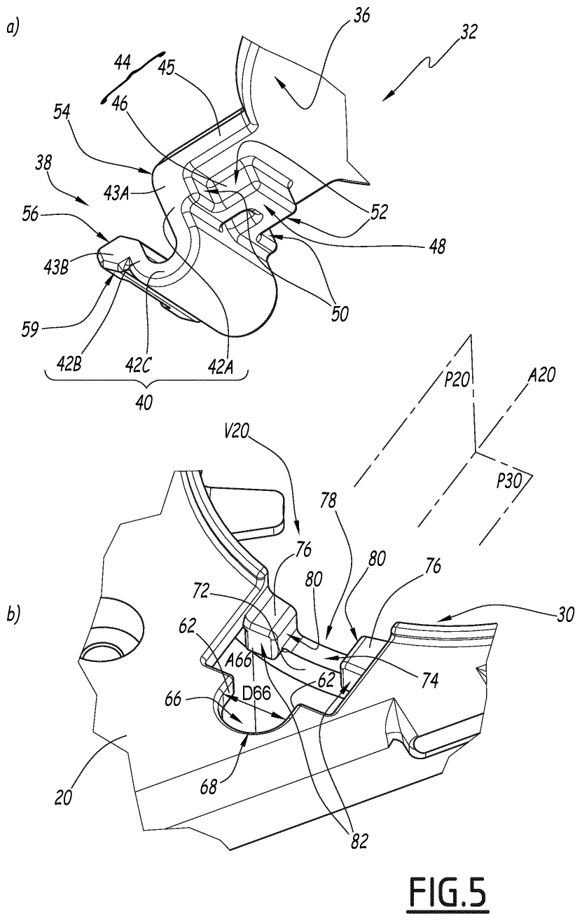

FIG. 5 shows, on two inserts a) and b) respectively, a perspective view of a detail of the cover of FIG. 3b, seen along an arrow Va, and a perspective view of a detail of the control unit of FIG. 3b, seen along an arrow Vb, and

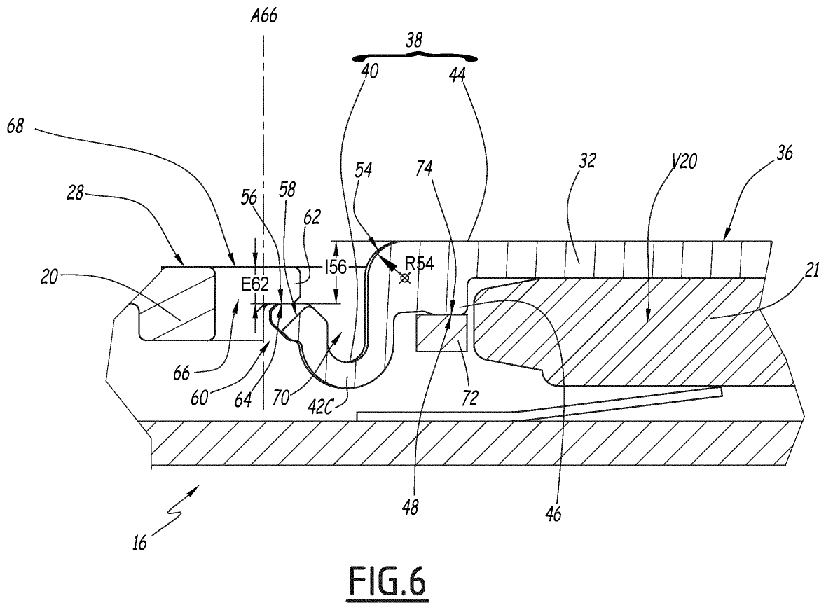

FIG. 6 is a partial cross-section of the control unit in the closed configuration along a longitudinal plane of the cover;

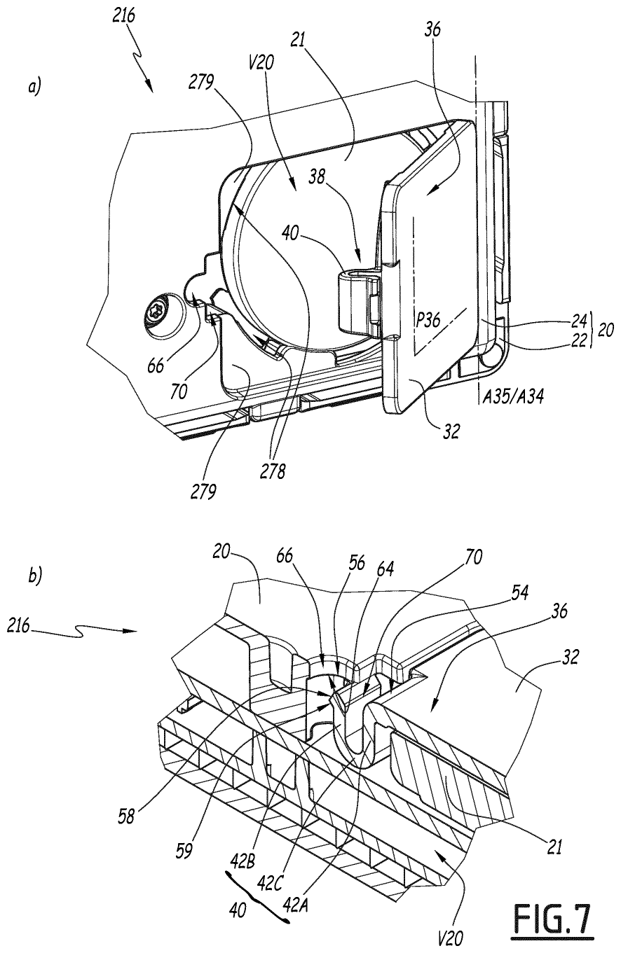

FIG. 7 shows, on two inserts a) and b), two details of a control unit according to a second embodiment of the invention, the control unit being shown, respectively, in perspective and in open configuration, and in perspective, in cross-section and in closed configuration, and

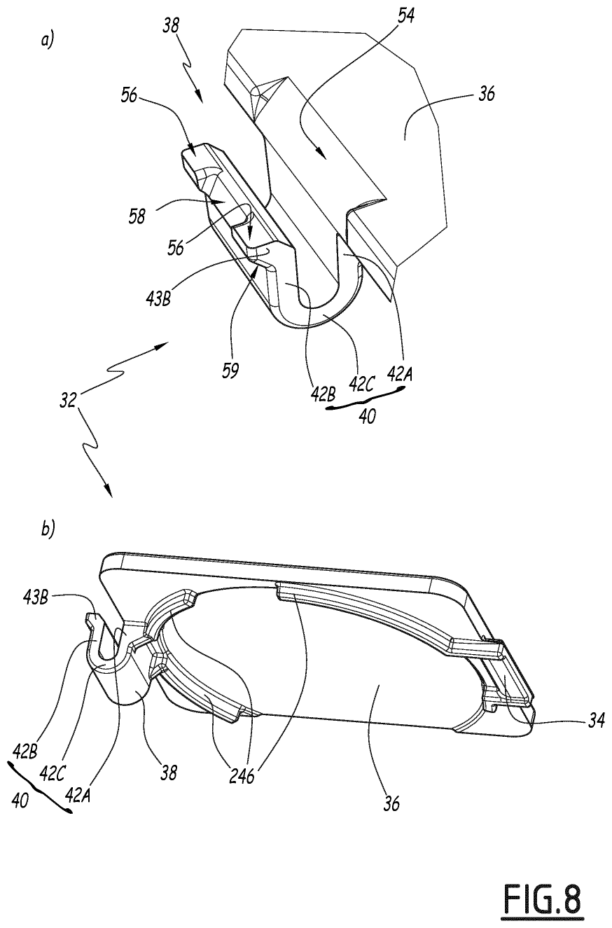

FIG. 8 shows, on two inserts a) and b), a cover of the control unit of FIG. 7, the cover being viewed from two different directions.

FIG. 1 shows a home automation installation 1. The home automation installation 2 is a closure system, in particular a roller shutter system, which partially closes an opening 4 in a wall 6. In a non-limiting variant, the home automation installation 2 is a solar protection system and/or comprises one or more lighting devices. In other words, the home automation installation 2 comprises one or more controllable devices.

In the example shown, the opening 4 is a window, which passes right through the wall 6. In a variant not shown, the opening 4 is a door, for example a garage door. The opening 4 is partially closed by a blackout screen 8, which is the roller shutter curtain.

The home automation installation 2 comprises a box 10, which is provided on an upper part of the opening 4 and delimits an internal volume in which a tube 12 for winding up the screen 8 is housed, particularly in the form of a winding tube. The tube 12 defines a horizontal winding axis A12. The blackout screen 8 is connected to the tube 12, and in particular rolls up on the tube 12, the tube 12 being mounted so that it can rotate freely relative to the box 10 about the winding axis A12. The shaft 12 is rotated by an electromechanical actuator 14, which is internal to the shaft 12.

The home automation installation 2 further comprises a control unit 16, in accordance with a first embodiment of the invention. The control unit 16 is configured to control one or more of the various items of equipment in the home automation installation 2. In the example shown, the electromechanical actuator 14 is controlled by the control unit 16, via control signals, for example wirelessly, transmitted by the control unit 16 and received by the actuator 14. “Control unit” means here a remote control device which communicates with the actuator 14. The control signal is represented by a lightning bolt 18 in FIG. 1.

The control signals 18 are received by the actuator 14 even when the electromechanical actuator 14 is located in the internal volume of the box 10, and are advantageously signals transmitted by radio waves. The control unit 16 thus comprises a radio wave transmission module, which is not shown or further detailed in this description.

In the example shown, the control unit 16 is shown fixed to the wall 6 in which the opening 4 is made. Of course, the control unit 16 may be fixed to a wall other than the wall 6, or it may not be fixed to any wall at all, in which case the control unit 16 is simply placed there for a user's convenience. As the control unit 16 is removably fixed to a wall or free-standing, it is referred to as a roaming control unit. The spatial constraint is in particular that the control unit 16 must be located in an area within radio range of the actuator 14.

The control unit 16 will now be described.

The control unit 16 comprises a main body 20, which is formed here by the assembly of a front portion 22, facing the user when the control unit 16 is fixed to a wall 6, and a rear portion 24, facing away from the front portion 22. The front portion 22, visible in FIG. 1, comprises a number of buttons 23 for controlling equipment in the home automation installation 2, for example arrow-shaped buttons 23A for controlling the raising or lowering of the roller shutter screen 8, round buttons 23B for switching light fixtures on or off, etc. The number, shape, arrangement and function of the buttons 23 on the control unit 16, which are provided on the front of the control unit 16, are not limiting. In the example shown, the control unit 16 also includes a bracket for mounting to a wall, in this case the wall 6. The mounting bracket comprises first mounting means, which cooperate with first mounting means on the main body 20, and second mounting means on the wall 6. The mounting bracket is not shown.

The main body 20 has an interior volume, which houses various components of the control unit 16, including a printed circuit board (PCB), etc. The circuit board is not shown. A portion of this interior volume is configured to receive one or more electric batteries, intended to supply power to the control unit 16. In other words, the main body 20 provides a battery compartment V20, i.e. a volume configured for receiving one or more batteries. In the example shown, compartment V20 is configured for holding a single battery, in this case a button cell 21, as shown in FIG. 6. The type and number of batteries are not limiting.

The compartment V20 opens onto an outer face 28 of the main body 20 through an opening 30. The outer face 28 is in this case a rear face of the control unit 16, in other words part of the rear portion 24. The opening 30 extends along a median plane P30, which is therefore carried here by the rear face of the control unit 16. The compartment V20 is formed on one side of the median plane P30 internal to the main body 20 and, by extension, mainly on the internal side of the median plane P30. The compartment V20 thus opens onto the outer face 28 through opening 30 and extends from a bottom of compartment V20 towards the opening 30 in a depth direction Z20 orthogonal to the median plane P30. The depth direction Z20 is therefore oriented towards the wall 6 when the control unit 16 is fixed to this wall.

In the example shown, the rear of the control unit 16 further comprises a button 31. The button 31 is used, for example, to switch the control unit 16 on or off, or to configure it, for example to pair the control unit 16 with the or one of the items of equipment in the home automation installation 2. Alternatively, the control unit 16 comprises, in addition to the button 31, other buttons on the rear panel. The number, arrangement, shape and functions of these buttons are not limiting.

The control unit 16 further includes a cover 32 for closing the compartment V20. The cover 32 comprises a hinge portion 34, a sealing portion 36 and a locking portion 38. The cover 32 is shown in isolation in FIG. 3b), while the locking portion 38 is shown on a larger scale in FIGS. 4b) and 5a).

The hinge portion 34 cooperates with the main body 20, for example in a form-fitting manner, so as to form a hinge, i.e. the cover 32 is rotatable relative to the main body 20 about an axis of rotation A34. In this sense, the cover 32 can also be described as a flap.

The axis of rotation A34 is parallel to the median plane P30. In the illustrated example, the hinge portion 34 comprises a tongue 35A, which has an elongate shape extending along a tongue axis A35, and which is received in a complementary recess 35B in the rear portion 24 to form the hinge in an engaged configuration of the cover 32. When the cover 32 is in the engaged configuration, the tongue axis A35 is coincident with the axis of rotation A34 and the cover 32 pivots relative to the rear portion 24 about the tongue axis A35. The axis of rotation A34 is a transverse axis of the compartment V20. By extension, the axis of rotation A34 is also a transverse axis of the cover 32, in the engaged configuration of the cover 32.

In a variant not shown in the figures, the cover 32 and the rear portion 24 are made of the same single piece. For example, the cover 32 and the rear portion 24 are made of a synthetic polymer material and are connected by a thinned portion, which is resiliently deformable and forms the hinge.

The cover 32 is thus movable relative to the main body 20 between a closed position, in which the sealing portion 36 closes the opening 30 and prevents access to the compartment V20, and an open position, in which access to the compartment V20 is possible through the opening 30. When the cover 32 is in the closed position, the control unit 16 is in a closed configuration, shown in FIG. 2. When the cover 32 is in the open position, the control unit 16 is in an open configuration, shown in FIG. 3. The switching of the cover 32 from its closed position to its open position takes place by an opening movement F32, i.e. a rotational movement of the cover 32 with respect to the main body 20 about the axis of rotation A34, the opening movement F32 being represented by an arc-shaped arrow in FIG. 3.

The sealing portion 36 has a generally flat shape and extends along a cover plane P36. The sealing portion 36 is configured to close the opening 30 in the closed position of the cover 32, the cover plane P36 then being parallel or coincident with the median plane P30 of the opening 30.

A longitudinal axis A32 of the cover 32 is defined as an axis radial to the tongue axis A35 and parallel to the cover plane P36. A longitudinal plane P32 of the cover 32 is a plane orthogonal to the cover plane P36 and bearing the longitudinal axis A32. The cover 32 has a generally symmetrical shape in relation to the longitudinal plane P32 of the cover 32. A height direction Z32 of the cover 32 is a direction orthogonal to the cover plane P36 and oriented in the same direction as the depth direction Z20 when the cover 32 is in the closed position. In other words, the height direction Z32 is collinear with the depth direction Z20 when the cover 32 is in the closed position.

A longitudinal axis A20 of the compartment V20 is also defined as an axis aligned with the longitudinal axis A32 of the cover 32 in the closed position. A longitudinal plane P20 of the compartment V20 is a plane coplanar with the longitudinal plane P32 of the cover 32 in the closed position, passing through the longitudinal axis A20.

The locking portion 38 comprises a locking clip 40. In the first embodiment, the locking portion 38 advantageously comprises a connecting lug 44, the clip 40 being connected to the sealing portion 36 by the connecting lug 44.

The locking portion 38 and the hinge portion 34 are located on two opposite sides of the sealing portion 36, along the longitudinal axis A32 of the cover 32. The side of the sealing portion 36 carrying the articulation portion is referred to as the proximal side, while the side of the sealing portion 36 carrying the locking portion 38 is referred to as the distal side, particularly with respect to the axis of rotation A34. By extension, this defines a distal side and a proximal side of the cover 32 with respect to the axis of rotation A34. A distal side and a proximal side of compartment V20 are also defined, which are defined with respect to the recess 35B and correspond respectively to the distal and proximal sides of the cover 32 in the closed position. The distal side of the compartment V20 is therefore located opposite the axis of rotation A34, while the proximal side of the compartment V20 is located on the side of the axis of rotation A34.

The clip 40 is U-shaped when projected onto the longitudinal plane P32 of the cover 32. The clip 40 comprises two walls 42A and 42B, which are connected to each other by a base 42C and which each have an end. The U-shaped clip 40 is open in the height direction Z32. The wall 42A is connected to the sealing portion 36 and is therefore a “captive” wall, while the other wall 42B is a “free” wall. The end of the captive wall 42A opposite the base 42C is a captive end 43A, by which the clip 40 is connected to the sealing portion 36, in particular by means of the connecting lug 44, while the end 43B of the free wall 42B opposite the base 42C is a so-called “locking” end, which is configured to cooperate with the main body 20 so as to hold the cover 32 in the closed position, in a locking configuration of the clip 40.

The U-shaped clip 40 is resiliently deformable between a deployed configuration of the clip 40 and a compressed configuration of the clip 40, the two ends 43A and 43B being closer together in the compressed configuration than in the deployed configuration. By springing back, the clip 40 tends to return to its deployed configuration. The base 42C of the U-shaped clip 40 is rounded, so that the resilient deformation of the clip 40 is distributed throughout the clip 40. In other words, stress concentrations are avoided when the clip 40 is deformed between its deployed configuration and its compressed configuration. “Rounded” means that the base 42C has a profile with a substantially continuous curvature and that the base 42C is connected substantially tangentially to both the captive wall 42A and the free wall 42B. In the example, the base 42C has a circular arc profile, i.e. with a constant curvature.

The connecting lug 44 connects the captive end 43A of the clip 40 to the sealing portion 36. The connecting lug 44 comprises an elongate connecting portion 45 and extends along its length towards the distal side of the sealing portion 36, parallel to the longitudinal axis A32. In cross-section, in a plane transverse to the longitudinal axis A32, i.e. in a plane orthogonal to the longitudinal axis A32, the connecting portion 45 has a flattened rectangular profile extending parallel to the cover plane P36.

Advantageously, the cover 32 comprises a reinforcement 46. The reinforcement 46 is provided on an inner side of the cover 32, the inner side facing the compartment V20 when the cover 32 is in the closed position. The reinforcement 46 projects and is designed to limit flexion of the captive wall 42A and the sealing portion 36 in the event of deliberate or inadvertent manipulation of the cover 32 in the closed position. In the first embodiment of the control unit 16, the reinforcement 46 projects from the connecting lug 44.

The shape of the reinforcement 46 is not limiting. As will be explained in greater detail below, the reinforcement 46 is configured to cooperate, in a form-fitting manner, with an indentation 78 formed in the main body 20, so as to prevent translational movements of the connecting lug 44 relative to the main body 20 parallel to the axis A32 or parallel to the axis of rotation A34, when the cover 32 is in the closed position. The reinforcement 46 is therefore also a centring reinforcement 46. The indentation 78 is described below.

The reinforcement 46 is generally parallelepiped-shaped, and forms stop faces together with the captive wall 42A. These stop faces here include a lower face 48, formed on the reinforcement 46, two transverse faces 50, formed on either side of the reinforcement 46 as an extra thickness on the captive wall 42A, and two lateral faces 52, formed on the reinforcement 46. The lower face 48 is oriented opposite the height direction Z32, parallel to the cover plane P36. The transverse faces 50 are orthogonal to the longitudinal axis A32 of the cover 32 and are oriented towards the proximal side of the cover 32, i.e. oriented towards the axis of rotation A34. The lateral faces 52 face away from each other parallel to the longitudinal plane P32, i.e. orthogonally to the axis of rotation A34.

On the external side of the cover 32, the sealing portion 36 and the clip 40 are connected to each other by a junction surface 54, which advantageously has a convex shape, configured to prevent a force directed towards the proximal side of the cover 32 from being exerted on the cover 32, in this case on the connecting lug 44, using a tool. The convex shape prevents stable positioning of the tool against the connecting portion and avoids the application of a sufficiently high force to cause bending of the sealing portion 36 when the cover 32 is in the closed position. In the first embodiment, the sealing portion 36 is connected to the clip 40 via the connecting lug 44, the connecting lug 44 extending parallel to the closure plane P36, while the junction surface 54 is provided at the junction of the connecting lug 44 and the clip 40.

In the example shown, the junction surface 54 has, projected in a plane transverse to the cover 32, i.e. a plane orthogonal to the longitudinal axis A32, a circular arc profile with a radius R54. In other words, the radius of curvature of the junction surface 54 is constant. The radius R54 of the junction surface 54 is equal to 2 mm. Alternatively, the value of this radius R54 may be different.

Alternatively, the junction surface 54 has a convex profile with a variable radius of curvature, or even comprises a flat portion, for example a flat portion inclined at with respect to the cover plane P36. By definition, a flat section has an infinite radius of curvature. In all cases, the junction surface 54 has a convex profile. Preferably, the radius of curvature R54 is greater than 1.5 mm, preferably greater than 2 mm. Preferably, the radius of curvature R54 is constant.

The locking end 43B here has two studs which project from the free wall 42B and each provide a blocking face 56. The two blocking faces 56 are arranged symmetrically on either side of the longitudinal plane P32. The blocking faces 56 are preferably flat and are oriented in the direction of the height Z32, parallel to the cover plane P36. The blocking faces 56 are preferably coplanar and are carried by a blocking plane P56.

The blocking faces 56 are set back in the height direction Z32 from the sealing portion 36. A setback gap 156 is defined as a distance, measured parallel to the height direction Z32, between each of the blocking faces 56 and the cover plane 36. The setback gap 156 is greater than or equal to 2 mm, preferably greater than or equal to 2.5 mm. In the example shown, the setback gap 156 is equal to 2.5 mm.

The locking end 43B further comprises a bearing face 58. The bearing face 58 is arranged between the two blocking faces 56 and set back relative to each blocking face 56, i.e. recessed relative to the blocking plane P56. The bearing face 58 is therefore not easily accessible by fingers or fingernails, which reduces the risk of accidental opening, for example by young children handling the control unit 16. This improves the safety of the control unit 16.

Advantageously, the bearing face 58 is inclined away from the captive wall 42A with respect to the height axis Z32. By extension, when the cover 32 is in the closed position, the bearing face 58 is inclined away from the captive wall 42A with respect to the depth direction Z20.

The bearing face 58 is here generally flat and has a normal axis A58, which is carried by the longitudinal plane P32, which comprises a first component, oriented away from the captive wall 42A, and a second component oriented in the same direction as the height direction Z32. The normal axis A58 forms, with the height direction Z32, an angle α58 of between 10° and 80°, preferably of between 20° and 70°, still more preferably of between 30° and 60°. In the example shown, the bearing face 58 is inclined on the distal side at an angle α58 equal to 30°. This inclination allows a tool to be guided to unlock the locking clip.

Thus, when a tool is brought to bear on the bearing surface 58, for example a tool such as the tip of a ballpoint pen, the tool generates a force on the bearing surface 58, one component of which is directed towards the sealing portion 36 of the cover 32 and tends to deform the clip 40 from its deployed configuration to its compressed configuration, allowing the opening movement F32 of the cover 32. The tool makes it easier to open the cover 32, which improves the overall ease of use of the control unit 16 without compromising safety.

The main body 20 is now described in detail.

The main body 20 comprises a complementary recess 60, which is configured to receive the locking end 43B of the wall 42B of the clip 40 when the cover 32 is in the closed position. In particular, the complementary recess 60 is configured to receive the locking end 43B when the clip 40 is in the deployed configuration.

The complementary recess 60 is formed on the distal side of the compartment V20 and opens towards the proximal side of the compartment V20, i.e. towards the axis of rotation A34. The complementary recess 60 is delimited, along the depth direction Z20, by two blocking walls 62, each blocking wall 62 extending parallel to the median plane P30 and providing a blocking surface 64 facing away from the depth direction Z20.

While the cover 32 is in the closed position, when the locking end 43B is received in the complementary recess 60, each blocking face 56 is opposite a respective blocking surface 64, preferably bearing against a respective blocking surface 64, preventing the opening movement F32 of the cover 32. The cover 32 is then in a locked configuration.

The blocking wall 62 has a thickness E62, measured parallel to the depth direction Z20 between each blocking surface 64 and the outer surface 28, which is greater than 2 mm, preferably greater than 2.5 mm and even more preferably greater than 3 mm. The blocking faces 56 and the locking end 43B are set back from the outer face 28. Access to the locking faces 56 is thus prevented, contributing to the safety of the control unit 16. The thickness E62 is 3 mm.

The main body 20 also comprises a gap 66, which is recessed into the outer surface 28 and extends parallel to the depth direction Z20.

The gap 66 is formed in the main body 20 opposite volume V20 with respect to the complementary recess 60 and connects complementary recess 60 to the outer face 28 of the main body 20. The gap 66 opens, on the one hand, onto the external surface 28 via a mouth 68 and, on the other hand, into the complementary recess 60 in the vicinity of each locking surface 64, so as to allow access to the bearing face 58 of the locking end 43B when the cover 32 is in the closed position. The bearing face 58 is thus accessible from the external surface 28 by means of a tool inserted into the gap 66.

A passage dimension D66 of the gap 66 is defined as being a maximum dimension, measured parallel to the median plane P30, between any two points on a contour of the gap 66. In the example shown, the gap 66 is cylindrical in shape, with a semi-circular cross-section centred on a gap axis A66 parallel to the depth direction Z20. The passage dimension D66 is therefore a diameter of this semicircle.

The passage dimension D66 is less than 5 mm, preferably less than 4 mm, even more preferably less than 3.5 mm, so as to prevent the insertion of a finger, in particular a child's finger or a standard test finger, while allowing the insertion of a pointed tool, such as the tip of a ballpoint pen or screwdriver.

For greater safety, a ratio between the passage dimension D66 and the thickness E62 should be as small as possible, for example less than 2.5, preferably less than 2 and even more preferably less than 1.5, so that only thin and long tools, or pointed or tapered tools, can fit inside.

The introduction of the unlocking tool is facilitated by a chamfer at the mouth 68 and by the inclination of the bearing face 58. Once inserted into the gap 66, the tool can be inclined and supported on the support surface 58 and on the walls of the main body 20 delimiting the gap 66, in order to impart to the latter a force which will tend to deform the clip 40 from its deployed configuration to its compressed configuration, as explained above.

The main body 20 further comprises a clearance 70, which is hollowed out in the main body 20 and is configured to receive most of the clip 40 of the cover 32 in the closed position or when the cover changes position from the closed position to the open position and vice versa, namely the walls 42A and 42B and the base 42C. The clearance 70 is located between the complementary recess 60 and compartment V20, on the distal side of the compartment V20.

When the cover 32 is in the closed configuration, the free end 43B of the clip 40 is received in the complementary recess 60. The clip 40 is thus mechanically connected to the main body 20 via the free end 43B. Similarly, the clip 40 is mechanically connected to the rest of the cover 32 via the captive end 43A.

Advantageously, when the cover 32 is in the closed position, the captive wall 42A, the free wall 42B and the rounded base 42C of the clip 40 are mechanically connected to the main body 20 only via the locking end 43B and the captive end 43A. In other words, apart from the captive 43A and locking 43B ends of the clip 40, the rest of the clip 40 is free from any point of contact with the main body 20 or with the rest of the control unit 16. The deformation of the U-shaped clip 40 is thus free from any external interference, so as to allow the captive end 43A and the locking end 43B to move towards each other.

Preferably, the mechanical connections of the locking end 43B and the captive end 43A of the captive wall 42A lie substantially in a same plane perpendicular to the depth direction Z20, this plane being set back from the median plane P30 in the depth direction Z20.

The complementary recess 60 opens onto the clearance 70, while the clearance 70 opens onto the compartment V20 and the outer face 28.

The main body 20 further comprises a partition 72, which separates compartment V20 and clearance 70. In the example, the partition 72 delimits the compartment V20 on its distal side and partially closes off the clearance 72 with respect to the compartment V20.

The partition 72 comprises an upper surface 74, which is oriented in the same direction as the depth direction Z20 and is set back from the median plane P30. When the cover 32 is in the closed position, the upper surface 74 faces the lower face 48 of the reinforcement 46. Preferably, the upper surface 74 rests against the lower face 48, so as to prevent the cover 32 from bending in the closed position when a force is exerted on the connecting lug 44.

The main body 20 also comprises two stops 76, each of which is substantially parallelepipedic in shape and arranged on either side of the longitudinal plane P20. The stops 76 project from the upper surface 74 of the partition 72. The stops 76 and the partition 72 together form the indentation 78, which is formed in the main body 20 and is configured to receive the reinforcement 46.

In the example shown, the two stops 76 each have a lateral surface 80 which extends parallel to the longitudinal plane P20 of the main body 20, the two lateral surfaces 80 facing each other. When the cover 32 is in the closed position, each lateral surface 80 faces a respective lateral face 52 of the reinforcement 46, preferably resting against a respective lateral face 52, so as to prevent movements of the clip 40 and the connecting lug 44 parallel to the axis of rotation A34.

The two stops 76 also each have a transverse surface 82, which extends transversely to the longitudinal axis A20 of the main body 20 and is oriented towards the clearance 70. The two transverse surfaces 82 are parallel here. When the cover 32 is in the closed position, each transverse surface 82 is opposite a respective transverse face 50 of the reinforcement 46, preferably bearing against a respective transverse face 50, so as to prevent movements of the clip 40 and the connecting lug 44 perpendicularly to the hinge axis A34 in the direction thereof. The cooperation of the transverse surfaces 82 and 50 also makes it possible to block the locking clip 40 against a force on the bearing surface 58, which makes it possible to deform the locking clip 40 and possibly open or close the cover 32.

More generally, the indentation 78 provides stop surfaces, which are arranged facing the stop faces of the cover 32 when the cover 32 is in the closed position, so as to prevent translational movements of the clip 40—and of the connecting lug 44—relative to the main body 20 towards the rear or parallel to the hinge axis A34. In the first embodiment, the clip 40 is connected to the sealing portion via the tab 44, and the stop surfaces also prevent movement of the connecting tab 44 relative to the main body 20 towards the rear or parallel to the hinge axis A34. The stop surfaces of the indentation 78 here include the lateral surfaces 80, the transverse surfaces 82, and advantageously the upper surface 74, while the stop faces of the reinforcement 76 here include the lateral faces 52, the transverse faces 50 and the lower face 48.

To open the cover 32, a user must therefore insert a fine tool into the gap 66 and generate pressure on the bearing surface 58. The locking clip, blocked in translation by the cooperation of the transverse surfaces 82 and 50, deforms resiliently, i.e. the ends 43B and 43A of the walls 42A, 42B will move towards each other and allow the locking clip 40 to pass through the clearance 70 and the cover 32 to be lifted from its closed configuration.

When the cover 32 is to be closed again, a force exerted perpendicularly to the cover brings the cover 32 and in particular the locking clip 40 into contact with the outer face 28 of the main body. In particular, the free end 43B of the clip 40 rests on part of the edges of the clearance 70.

The free end 43B comprises a lower surface 59 which is chamfered, so that a bearing force exerted perpendicularly to the cover 32 leads to resilient deformation of the clip 40 by cooperation between the edge of the clearance 70 and the lower surface 59. The clip 40 then assumes its compressed configuration.

In this way, the ends 43B and 43A of the walls 42A, 42B will move towards each other and allow the locking clip 40 to pass through the clearance 70 and the cover 32 to return to its closed configuration. The clip 40 springs back to its deployed configuration after passing through the release 70. No tools are required to close and lock the cover 32.

A control unit 216 in accordance with a second embodiment of the invention is shown in part in FIGS. 7 and 8. In the second embodiment, elements similar to those in the first embodiment have the same references and function in the same way. The main differences between the first and second embodiments are described below.

One of the main differences with the first embodiment is that in the second embodiment, the locking portion 38 does not comprise the connecting lug 44 of the first embodiment. In other words, the clip 40 is directly connected to the sealing portion 36. The sealing portion 36 has a generally rectangular shape.

In the second embodiment, the cover 32 comprises a reinforcement 246, which projects from the sealing portion 36 on the inside of the cover 32. The reinforcement 246 is formed here by ribs with arcuate portions, the ribs extending perpendicularly to the cover plane P36. The reinforcement 246 thus contributes to the overall rigidity of the cover 32.

The reinforcement 246 is configured to cooperate, in a form-fitting manner, with an indentation 278 formed in the main body 20, so as to prevent translational movements of the clip 40 relative to the main body 20 parallel to the axis A32 or parallel to the axis of rotation A34, when the cover 32 is in the closed position. The reinforcement 246 advantageously helps to keep the battery 21 centred in the compartment 30. The reinforcement 246 is therefore also a centring reinforcement 246. In the second embodiment, the indentation 278 is formed by grooves, which are formed at the periphery of the compartment V20, between the battery 21 and stops 279 of the main body 20.

More generally, it is understood that the reinforcement 246 provides stop faces for the cover 32, while the indentation 278 provides stop surfaces for the main body 20. The stop surfaces of the indentation 278 are arranged opposite stop faces of the cover 32 when the cover 32 is in the closed position, so as to prevent translational movements of the clip 40 relative to the main body 20 towards the rear or parallel to the hinge axis A34.

In the closed position of the cover 32, the sealing portion 36 advantageously rests against the stops 279. When the battery 21 is present in the compartment V20, the sealing portion 36 also rests against the battery 21. Thus, when a force having a component normal to the cover plane P36 is exerted on the cover 36 in the closed position, this component is taken up by the stops 279 and the battery 21, which limits the deformation of the sealing portion 36, and thus reduces the risk of the cover 32 being opened by hand.

Likewise, when a force having a component tangential to the cover plane P36 is exerted on the cover 36 in the closed position, this component is taken up by the reinforcement 246, the battery 21, and the indentations 278, which limits the deformation of the sealing portion 36, and thus reduces the risk of the cover 32 being opened by hand.

In the example shown, as in the first embodiment, the junction surface 54 has, projected in a plane transverse to the cover 32, i.e. a plane orthogonal to the longitudinal axis A32, a circular arc profile with a radius R54, preferably greater than 1.5 mm, more preferably greater than 2 mm. This makes it possible to avoid stable positioning of a tool or finger against the connecting portion to manipulate the cover 32.

Preferably, the battery 21 received in the compartment V20 is immobilised relative to the main body 20. Thus, when the cover 32 is in the open position and a battery 21 is received in the compartment V20, the battery 21 tends to remain in place in the compartment V20, unless of course the open control unit 216 is subjected to a shock, or the battery 21 is deliberately dislodged, for example with a tool such as a screwdriver. In the illustrated example, the battery 21 is mounted with an interference fit in the compartment V20, the main body 20 comprising ribs, i.e. beads of material, which are provided at the periphery of the battery compartment V20 and which are resiliently deformable to accommodate the insertion of the battery 21 into the compartment 20. Furthermore, one portion of the battery 21 is held under an edge of the main body 20 projecting beyond the compartment V20 for receiving the battery 21.

The above-mentioned embodiments and variants can be combined to generate new embodiments of the invention.

1. A control unit for a home automation installation, the control unit comprising:
a main body, which provides a compartment for receiving one or more batteries, the compartment opening out in a depth direction on an outer face of the main body via an opening which extends in a median plane orthogonal to the depth direction,
a cover for closing the compartment, the cover:
being rotatable relative to the main body about an axis of rotation parallel to the median plane, the axis of rotation being located on a so-called proximal side of the compartment, and
being movable relative to the main body in an opening movement between a closed position, in which the cover prevents access to the compartment, and an open position, in which the cover does not prevent access to the compartment,
in which:
the cover comprises:
a hinge portion, configured to cooperate with the main body so that the cover is rotatable relative to the main body about the axis of rotation,
a sealing portion, which is configured to close the opening when the cover is in its closed position, and
a locking clip, which is located on one side of the cover, opposite the hinge portion with respect to the sealing portion, the clip having a U-shape with a captive wall and a free wall connected to each other by a rounded base, the free wall comprising a free end referred to as the locking end, which is configured to be received in a complementary recess formed in the main body when the cover is in the closed position, preventing the opening movement of the cover, the cover then being in a locked configuration,
when the cover is in the closed position, the clip is located on one side of the median plane internal to the main body, with the locking end set back from the outer face, while an opening of the U is oriented in the same direction as the depth direction,
the clip is resiliently deformable between a deployed configuration and a compressed configuration, the clip tending, by resilient return of the rounded base, to return to its deployed configuration,
the cover is in its locked configuration when the cover is in the closed position and the clip is in the deployed configuration, and
when the cover is in its closed position and the clip is in its compressed configuration, the clip does not prevent the opening movement of the cover and the cover is in an unlocked configuration.

2. The control unit according to claim 1, wherein the sealing portion extends along a cover plane, which is parallel, in particular substantially coplanar, to the median plane when the cover is in the closed position.

3. The control unit according to claim 1, wherein the captive wall, the free wall and the rounded base of the clip are in mechanical connection with the main body only via the locking end and via a captive end of the captive wall, opposite the base of the clip and connected to the sealing portion.

4. The control unit according to claim 3, wherein the mechanical connections of the locking end and of the captive end of the captive wall lie substantially in a same plane perpendicular to the depth direction and set back from the median plane in the depth direction.

5. The control unit according to claim 1, wherein:
the complementary recess comprises at least one blocking wall, each blocking wall providing a blocking surface facing away from the depth direction,
the locking end comprises at least two blocking faces, each blocking face bearing against a respective blocking surface when the cover is in the locked configuration, preventing opening movement of the cover,
the blocking faces are set back, in the depth direction when the cover is in the closed position, with respect to the sealing portion.

6. The control unit according to claim 1, wherein:
the main body comprises a clearance, which is recessed into the main body and is arranged between the complementary recess and the compartment,
the complementary recess opens onto the clearance, which itself opens onto the outer face, the clearance being configured to receive a part of the clip when the cover is in the closed position,
the main body also comprises a gap, which extends in the depth direction, which is formed in the main body and which connects the complementary recess to the outer face of the main body, the gap opening into the complementary recess in the vicinity of each locking surface, so as to allow access from the outer face to a bearing face of the locking end when the cover is in the locked configuration, the bearing face being located in the vicinity of each locking surface.

7. The control unit according to claim 6, wherein the gap has a passage dimension, measured between any two points on a contour of the gap parallel to the median plane, which is less than 5 mm, preferably less than 4 mm, more preferably less than 3.5 mm.

8. The control unit according to claim 6, wherein:
the bearing surface is set back from each blocking face,
the bearing surface is inclined away from the captive wall relative to the height axis, the height axis being colinear with the depth direction when the cover is in the closed position.

9. The control unit according to claim 6, wherein the gap has a chamfered opening and surfaces delimited by the blocking walls and the main body providing an area for inserting and supporting a tool in the gap.

10. The control unit according to claim 1, wherein:
the cover comprises a centring reinforcement, which is formed so as to project from the inside of the cover and which, together with the captive wall forms stop faces,
the reinforcement is configured to cooperate, in a form-fitting manner, with an indentation formed in the main body, the indentation forming stop surfaces, which are arranged opposite the stop faces of the reinforcement when the cover is in the closed position, so as to prevent translational movements of the clip perpendicular to the axis of rotation towards it or parallel to the axis of rotation.

11. A control unit according to claim 10, wherein the stop faces include:
at least one transverse face, each transverse face being oriented towards the hinge axis when the cover is in the closed position, and
two lateral faces, which face away from each other orthogonally to the hinge axis when the cover is in the closed position.

12. The control unit according to claim 1, wherein:
on the outer side of the cover, the sealing portion and the clip are connected by a junction surface,
the junction surface has projected in a longitudinal plane of the cover, a convex profile with a radius of curvature.

13. A home automation installation, in particular a closure or solar protection installation, comprising a control unit according to claim 1.
